(19) United States
(12) Patent Application Publication
(10) Pub. No.: US 2025/0369779 A1
(43) Pub. Date: Dec. 4, 2025

(54) SIGNAL INTERLEAVING METHOD IN MULTI-BAND DAS USING CORRELATION-BASED POLARIZATION

(71) Applicant: NEC Laboratories America, Inc., Princeton, NJ (US)

(72) Inventors: Junqiang HU, DAVIS, CA (US); Yue-Kai HUANG, PRINCETON, NJ (US)

(73) Assignee: NEC Laboratories America, Inc., Princeton, NJ (US)

(21) Appl. No.: 19/218,519

(22) Filed: May 26, 2025

Related U.S. Application Data
(60) Provisional application No. 63/652,301, filed on May 28, 2024.

(51) Int. Cl. G01D 5/353; G01H 9/00

(52) U.S. Cl. CPC G01D 5/35361; G01H 9/004

(57) ABSTRACT

Methods for a DFOS/DAS system that uses a Rayleigh backscattering optical signal, employs a transmitter/interrogator that generates optical signals with multiple frequencies and directs the generated optical signals into a optical fiber sensor, receives, by a receiver, backscattered signals, processes each frequency received and combines and interleaves frequency bands for improved signal-to-noise and a faster sampling rate. The receiver uses a correlation method for polarization and band combining/interleaving, that rotates the polarization and band diversities into a direction of one with highest averaged power, by aligning a same location along the length of the optical fiber sensor from different bands to a same clock cycle, apply correlation methods to the band diversities, to rotate the same location from the different bands to the same direction, and combines sub-bands allocated for SNR improvement, and delays resulting bands and interleaves them.

### CROSS REFERENCE TO RELATED APPLICATIONS

This application claims the benefit of U.S. Provisional Patent Application Ser. No. 63/652,301 filed May 28, 2024, the entire contents of which is incorporated by reference as if set forth at length herein.

### FIELD OF THE INVENTION

This application relates generally to distributed fiber optic sensing (DFOS) systems, methods, and structures. More particularly, it pertains to improved DFOS methods employing signal interleaving in multi-band coherent Distributed Acoustic Sensing (DAS) that uses a correlation method in polarization diversity combining.

Operationally, our inventive method is employed in a DFOS/DAS system that uses a Rayleigh backscattering optical signal, employs a transmitter/interrogator that generates optical signals with multiple frequencies and directs the generated optical signals into a optical fiber sensor, receives, by a receiver, backscattered signals, processes each frequency received and combines and interleaves frequency bands for improved signal-to-noise and a faster sampling rate. The receiver uses a correlation method for polarization and band combining/interleaving, that rotates the polarization and band diversities into a direction of one with highest averaged power, by aligning a same location along the length of the optical fiber sensor from different bands to a same clock cycle, apply correlation methods to the band diversities, to rotate the same location from the different bands to the same direction, and combines sub-bands allocated for SNR improvement, and delays resulting bands and interleaves them.

### BACKGROUND OF THE INVENTION

As those skilled in the art will understand and appreciate, in multi-carrier interleaving DAS, correlation-based polarization combining results in random phase relationships for the same location along the length of an optical sensor fiber using different carriers. The phase signal must be aligned properly to produce a meaningful interpolated output.

### SUMMARY OF THE INVENTION

An advance in the art is made according to aspects of the present disclosure directed to systems and methods that employ multi-band DAS and correlation methods in polarization diversity combining, our inventive method providing meaningful interpolated output alignment while producing an interleaved output signal suitable for firmware implementation.

In sharp contrast to the prior art, systems and methods according to aspects of the present disclosure

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing an illustrative transmitted signals in multi-carrier DAS according to aspects of the present disclosure.

FIG. 3 is a schematic block diagram showing illustrative multi-band coherent DAS according to aspects of the present disclosure.

FIG. 4 is a schematic diagram showing illustrative bands for interleaving and combining according to aspects of the present disclosure.

FIG. 5 is a schematic diagram showing illustrative digital signal processing (DSP) in multi-band DAS according to aspects of the present disclosure.

FIG. 6 is a schematic diagram showing illustrative alignment of bands according to aspects of the present disclosure.

FIG. 7 is a schematic diagram showing illustrative bands interleaving according to aspects of the present disclosure.

FIG. 8 shows a feature diagram in hierarchical format of features and operation steps of systems and methods according to aspects of the present disclosure.

FIG. 9 is a schematic block diagram of an illustrative computer system in which aspects of the present disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

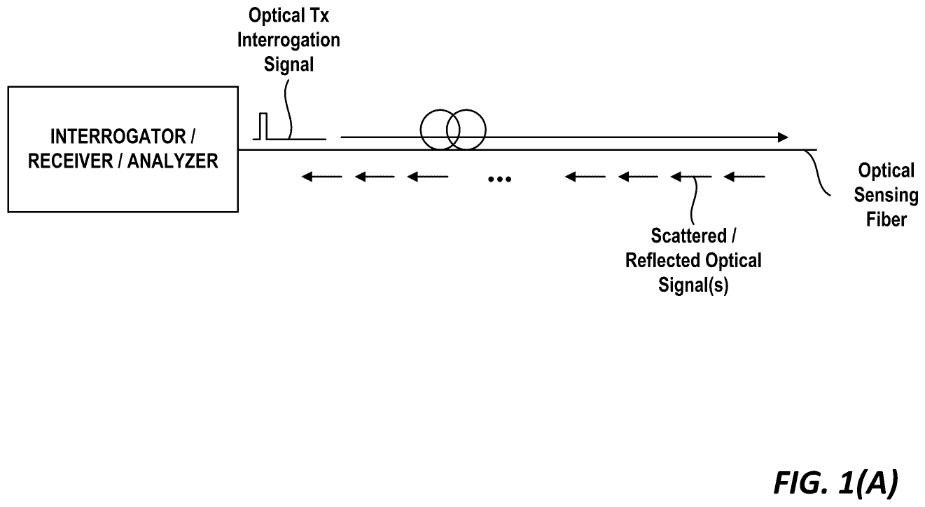

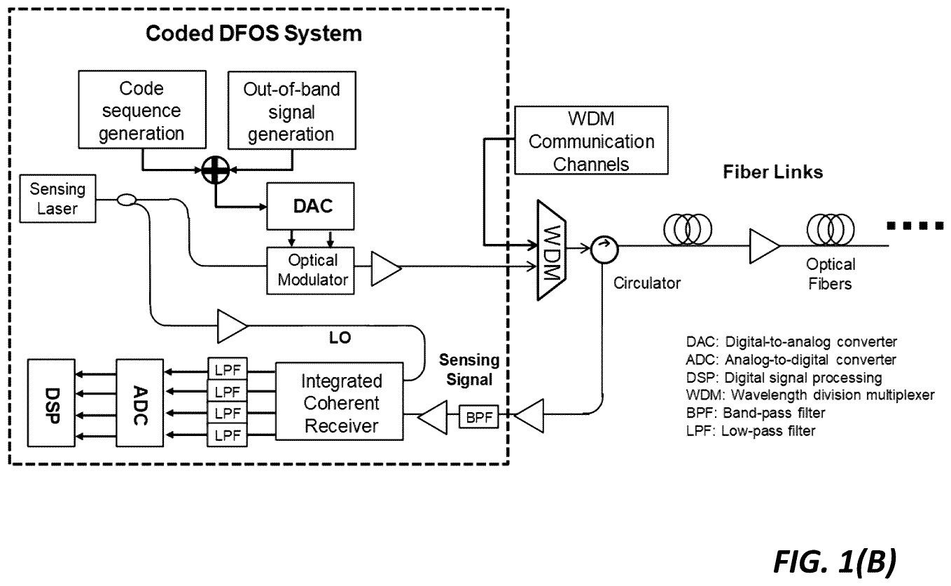

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detect/analyze reflected/backscattered and subsequently received signal(s). The signals received are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration or an indication of temperature.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

As previously noted, a basic principle behind the DFOS is that optical fiber cable conditions such as a change of strain or temperature on the optical fiber cable can influence the properties of the light signal traveling through an optical fiber. When pulsed light is launched into an optical fiber sensing cable, a small fraction of light is backscattered, and its properties are influenced by the fiber cable condition. The backscattered light includes three types of scattering: Raman scattering, Brillouin scattering, and Rayleigh scattering. This methodology gauges alterations in Rayleigh scattering intensity via interferometric phase beating. With coherent detection, the DFOS system retrieves comprehensive polarization and phase information from the backscattering signals, enabling impressive meter-level optical sensor fiber resolution.

As we have previously noted, aspects of the present disclosure describe a signal interleaving method in multi-band coherent DAS (Distributed Acoustic Sensing) that uses correlation method in polarization diversity combining.

As noted further, DAS systems use Rayleigh scattering effects in an optical sensor fiber to detect changes in the optical fiber strain. The obtained dynamic strain signals are used to determine vibration and acoustic signals—with location information—affecting the optical sensor fiber along the entire length of the optical fiber when interrogated by a DFOS/DAS interrogator. In multi-carrier DAS, different frequencies (or called bands) are used and equally spaced in one frame period to increase the sampling rate.

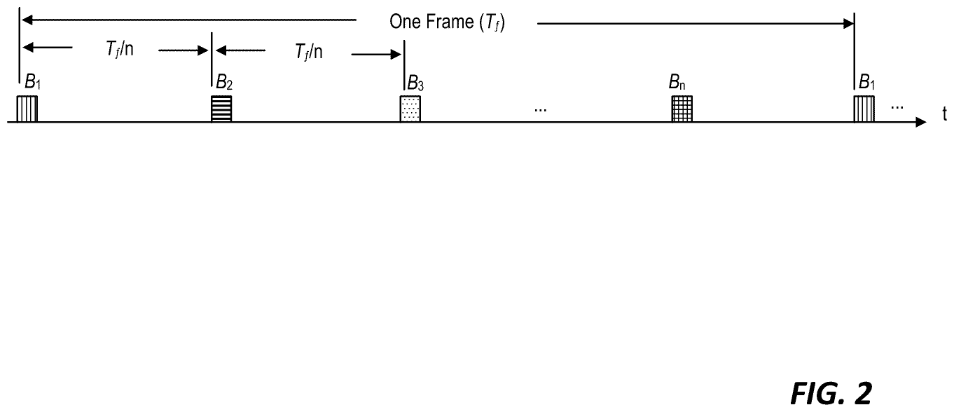

FIG. 2 is a schematic diagram showing an illustrative transmitted signals in multi-carrier DAS according to aspects of the present disclosure.

We note that the frame period is commonly set to slightly longer than the light's round-trip flight time in the fiber. For every frequency band in one frame time, each sensing location is sampled once, so the sampling rate becomes n/T_{f}, which is n times the repetition rate of a single carrier

Coherent DAS extracts the phase from the received complex signal to detect the strain. Specifically, it uses the phase difference between every two locations (spaced by m samples where m is positive integer) to detect the phase change (which reflects the vibration) in between. This procedure is called beating, of which the output is used to determine the dynamic strain along the fiber section. Coherent receiver outputs the complex signal in orthogonal polarizations, named X and Y, so the beating process generates four products ζₓₓ, ζ_{yy}, ζ_{xy}, ζ_{yx} for X-X, Y-Y, X-Y, and Y-X beating respectively.

Previously, we have disclosed A Polarization Diversity Combining Method in Coherent DAS Maintaining Phase Continuity which was patented in Untied States U.S. Pat. No. 11,692,867 and described the combination of four polarization diversities into a single complex output, which is called correlation-based polarization combining method. The entire contents of that U.S. Pat. No. 11,692,867 is incorporated into this disclosure by reference as if set forth at length herein.

In multi-carrier interleaving DAS case, correlation-based polarization combining method results in random phase relationship for the same location using different carriers. The phase signal must be aligned properly to have meaningfully interpolated output. This invention is to provide a method for this alignment, and how to make the output signal interleaved, for firmware implementation in streaming mode.

As we shall show and describe, our inventive method employs a method we have previously disclosed in U.S. Pat. No. 11,692,867 which described each frequency band for polarization diversity combining, resulting in a single complex signal from each band.

Our method delays each frequency band (i.e., B₁ to Bₙ₋₁ in FIG. 2) with the last one (i.e., band Bₙ in FIG. 2), such that each location along the length of the optical sensor fiber is aligned in time-domain among all the bands.

Our method applies the phase alignment method generally described in our U.S. Pat. No. 11,692,867, by treating each frequency band as a polarization diversity, to rotate the different bands signal to the same direction. Unlike that method disclosed in our patent however, that sums the aligned signal to a single output, our inventive method of this application skips the combining process, to have outputs for all the interleaved bands.

Finally, our method delays the bands such that an equal spacing is achieved between, and merges the multi-bands output to a single stream, producing an interleaved data stream.

Accordingly, methods according to aspects of the present disclosure advantageously treats the multi-carriers in similar way as polarization diversity, by aligning them in time domain. Then the phase of each location in the different carriers are rotated to the same direction. After the rotation, the signals of different carriers are delayed to have equal spacing, and merged into a single stream.

The present invention also includes a spatial averaging step, providing further sensitivity improvement. This includes the step of one band to calculate the rotation for each location, and outputting the rotation value to other bands, such that all bands apply that parameter and perform special averaging.

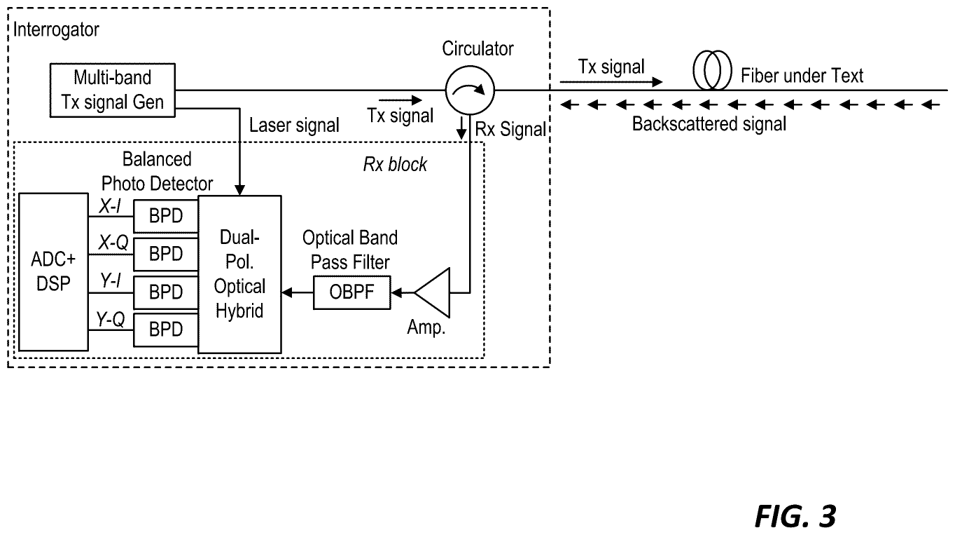

FIG. 3 is a schematic block diagram showing illustrative multi-band coherent DAS according to aspects of the present disclosure.

As noted, our instant disclosure describes a multi-band coherent DAS system using backscattered optical signal. FIG. 3 illustrates a simplified architecture of such a system, that includes an interrogator, and an attached optical fiber sensor-which those skilled in the art may be part of a larger, optical fiber cable that may further convey live telecommunications traffic.

The illustrative interrogator includes a multi-band transmission signal generator, which outputs an optical interrogation signal having multi-frequency bands; a circulator that directs a Tx interrogator signal to the optical fiber sensor, and directs backscattered signals to receiver (Rx) optics.

The Rx optics uses coherent detection which includes dual-polarization optical hybrid and four balanced photonic detectors, converts the received optical signals into electrical signals and complex domain, resulting in two polarizations X and Y, and each containing in-phase (I) and quadrature (Q) elements. The electrical signals are digitized by one or more analog-to-digital converters (ADCs) and further processed by a digital signal processor (DSP).

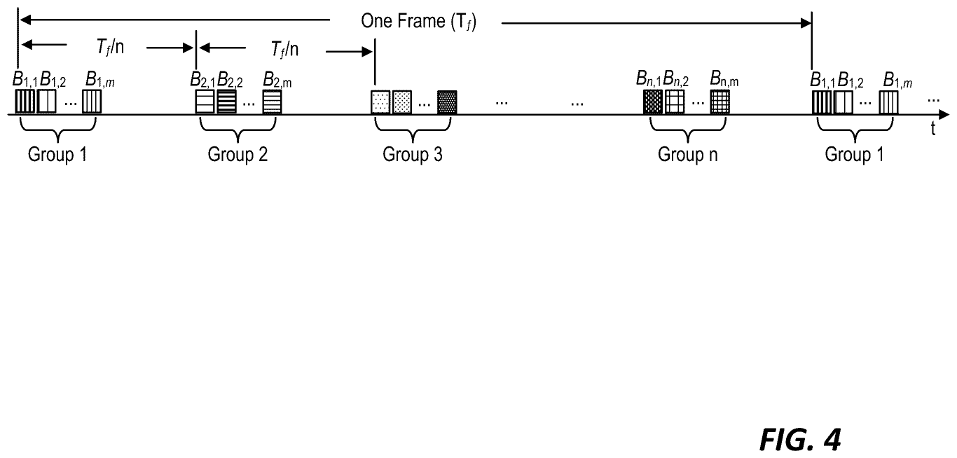

FIG. 4 is a schematic diagram showing illustrative bands for interleaving and combining according to aspects of the present disclosure.

As illustrated, this figure illustrates the Tx signal output from the multi-band signal generator, in greater detail than previously illustrated in FIG. 2. Here, the interleaved bands are called the “band groups”, each containing m sub-bands. There are n band groups that are spaced equally in frame period T_{f}, for n-time interleaving. The multi-bands in each band group are for the purpose of reduced Rayleigh fading and increased SNR. The signal of each sub-band can be called a “pulse”, which can be a single tone, or certain pattern, such as frequency-sweeping code. The frame period T_{f} is no less than the light's round-trip time to the end of the fiber, so that within each band, the backscattered signal from different locations does not overlay with each other

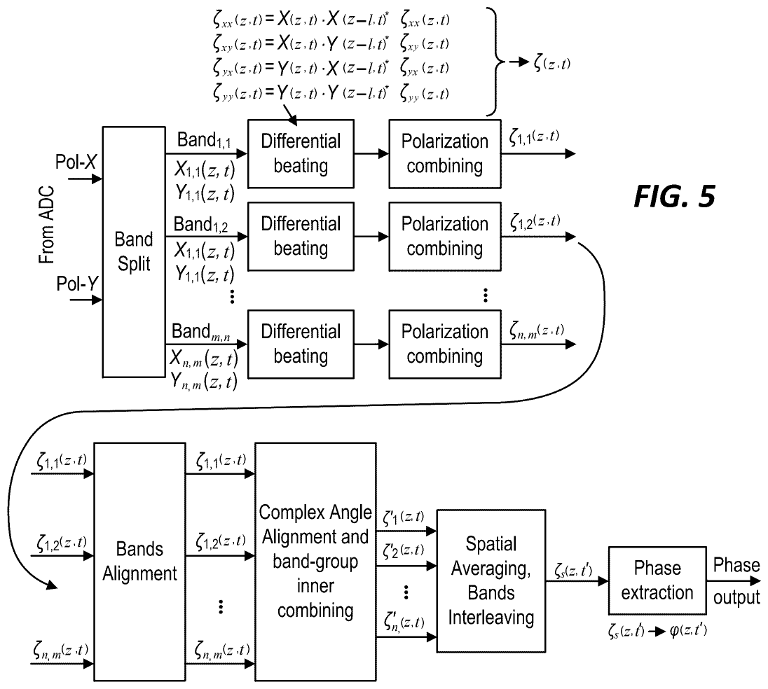

FIG. 5 is a schematic diagram showing illustrative digital signal processing (DSP) in multi-band DAS according to aspects of the present disclosure.

With reference to that figure, shown therein is a receiver side processing procedure, where the “Bands Alignment, “Complex Angle Alignment and Band-Group Inner Combining”, and “Spatial Averaging Bands Interleaving” blocks are the focus of the present invention, that can be implemented in firmware (e.g., ASIC—Application Specific Integrated Circuit, or FPGA—Field Programmable Gate Array).

The coherent detector shown illustratively in FIG. 3 outputs complex signals X and Y for the two polarizations, which are digitized by the ADC to have X(z, t) and Y(z, t), where z is the location along the fiber, and t is the time sequence for that location. Differential beating generates four polarization diversities (ζₓₓ, ζ_{xy}, ζ_{yx}, and ζ_{yy}) using the product of complex conjugate, where l in FIG. 4 is the distance of the locations called “beating gauge”. Within each sub-band, polarization combining aligns the phase of the 4 polarizations and add together to have one output ζ_{i,j}(z, n) (i=1, . . . n, j=1, . . . ,m), using our previously disclosed method.

According to the present disclosure, the present invention takes the polarization combined signals ζ_{i,j}(z, t) in accordance with band B_{i,j} and generates interleaved stream ζₛ (z, t′). The first module is for bands alignment, that aligns signals ζ_{i,j}(z, t) with ζ_{n,m}(z, t) in time-domain for all i and j. This makes signals ζ_{i,j}(z, t) present in the same clock cycle, for the given location z and time t. The module following the alignment is “complex angle alignment and band-group inner combining”, that rotates all the complex signals ζ_{i,j}(z, t) (i.e., the complex vectors) of location z to the same short-term averaged direction. The method used in this rotation is the same as in polarization combining. The complex signals that belong to the same group, such as signal ζ_{i0,j}(z, t) of group i₀. are added together to have a single output, for location z and time t. The subsequent signal ζᵢ′(z, t) are spatially averaged for location z using its adjacent locations, to further improve the SNR by sacrificing the spatial resolution, which is optional. This signal is then arranged to have interleaved stream ζₛ(z, t′) which has n times faster sampling rate. Phase signal φ(z, t′) can be extracted from the complex stream ζₛ(z, t′).

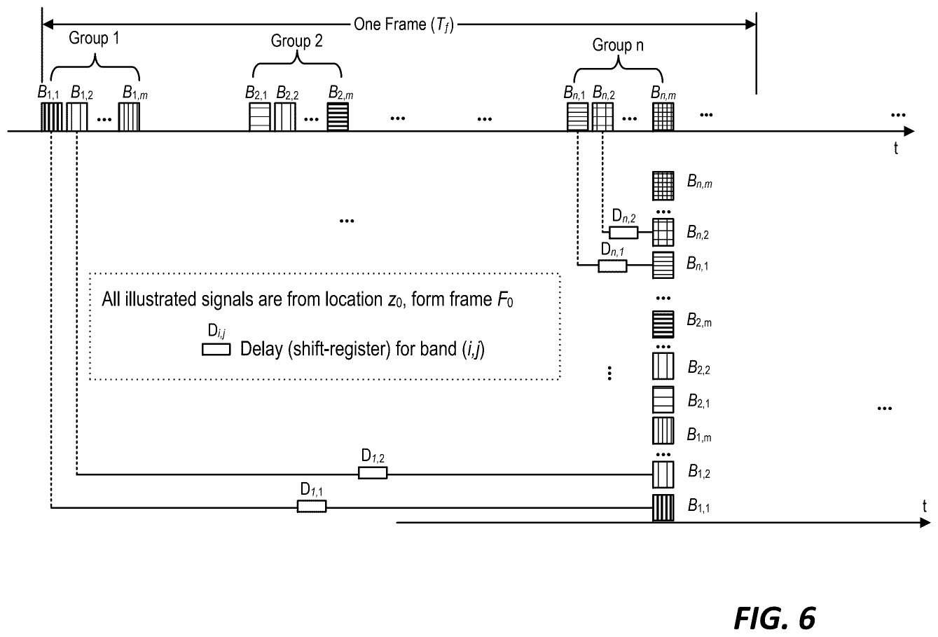

FIG. 6 is a schematic diagram showing illustrative alignment of bands according to aspects of the present disclosure.

### Bands Alignment

Bands alignment delays the different bands signal (e.g., using shift register) to align the same location with the last band, i.e., band B_{n,m}, in time domain as shown in FIG. 5. This makes signals ζ_{i,j}(z, t) synchronized to the same clock cycle, for the given location z and time t.

### Complex Angle Alignment and Band-group Inner Combining

The complex angle alignment uses the method we previously disclosed in U.S. Pat. No. 11,692,867 and have incorporated by reference into this disclosure, by considering the bands diversity same way as “polarization diversity”. This step is the processing for each location z, over time t. The idea is to rotate each band so that the time average at location z points to the same direction, for all the bands. The steps are:

First, calculate the averaged power for signal ζ_{i,j}(z, t) (i=1,2, . . . ,n, j=1,2, . . . ,m) using a low-pass filter, for location z over time t, to have [symbol] . Look for the band with the highest power at time t, say it's band B_{p,q}.

Next, calculate the average of signal ζ_{i,j}(z, t) using a low-pass filter, to have [symbol] , for location z over time t.

For each band B_{i,j} that (i,j)≠(p,q), calculate the angle difference with B_{p,q} from the averaged signal, using [symbol] * [symbol] where [symbol] is the complex conjugate of [symbol] .

Finally, assume B_{p,q} was rotated by complex signal ζ^{l}_{p,q}(z, t) in last calculation, then rotate signal ζ_{i,j}(z,t) by [symbol] * [symbol] *ζ^{l}_{p,q}(z, t)

This procedure makes all the bands aligned to the same average direction, so they can be summed together and/or interleaved for the highest performance and maintaining the phase continuity. After the above rotation, for signals within the same group, are added together, which is called “band-group inner combining”; the sum of signals from different groups are kept and to be interleaved in later process.

### Spatial Averaging

Spatial averaging is for further SNR improvement and/or fading elimination, to use moving average “spatially” over the locations along the fiber. This step uses the method proposed in IR20073 (“A spatial averaging method for coherent DAS”), with additional process that:

From the n bands output of the previous module, select one as “pilot band”. This selection can be the pre-defined band, or following certain procedure, such as using the band with the highest power for the given location.

Using the method we described in U.S. Pat. No. 11,692,867, calculate the rotating angle for each location, in the corresponding pilot band. Output the rotating parameters.

For all the other bands, for the corresponding locations, use the parameter obtained from the pilot band to rotate its signal, then do the subsequent procedure as in IR20073 to achieve spatial averaging.

Now, the locations of each band are spatially averaged, while maintaining the alignment of the directions among the bands. The different bands are ready to be interleaved for higher sampling rate.

### Bands Interleaving

Let the spatially averaged signals be ζᵢ″(z, t) for band i, location z, at time index t. Bands interleaving is to arrange the bands to have streaming output ζₛ′(z, t′) for location z at time index t′, where t′=n*z+i, for band i=1,2, . . . ,n.

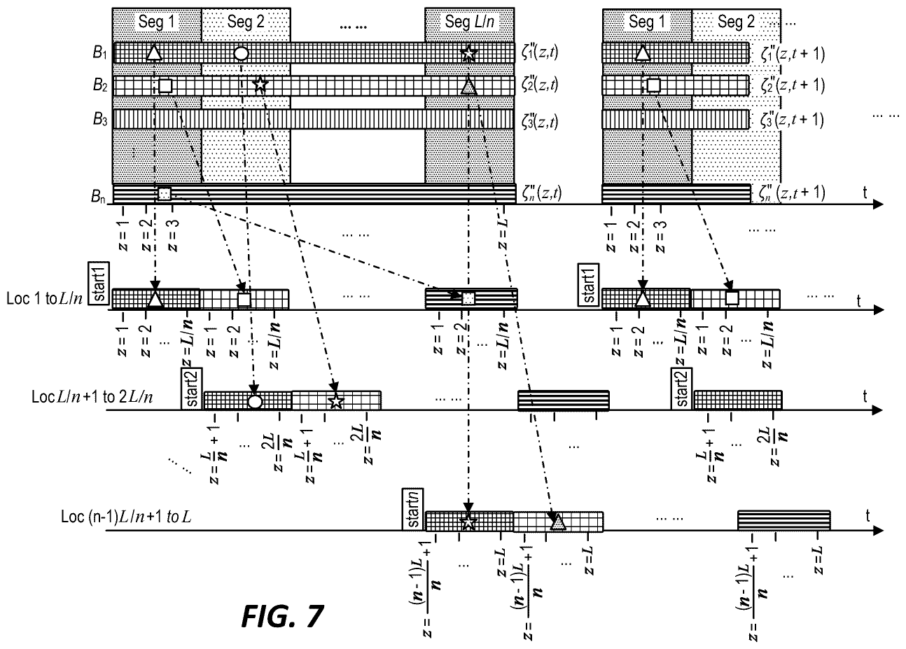

Assume the system supports L locations, each using one clock cycle. The present invention divides the L clock cycles into n segments and generates n parallel outputs. The first parallel output contains locations 1 to L/n, the second output for locations L/n+1 to 2L/n, and so on. Within each parallel output, signal ζᵢ″(z, t) is placed into segment i, to make the n bands interleaved, by delaying band i for (i−1) *L/n clock cycles then merging into the same stream. This is shown in FIG. 7, which is a schematic diagram showing illustrative bands interleaving according to aspects of the present disclosure. Note that each parallel output has its own start indicator, to identify the start of one frame. As may be observed from this figure, the start of each parallel output has L/n clock cycles latency than its previous one.

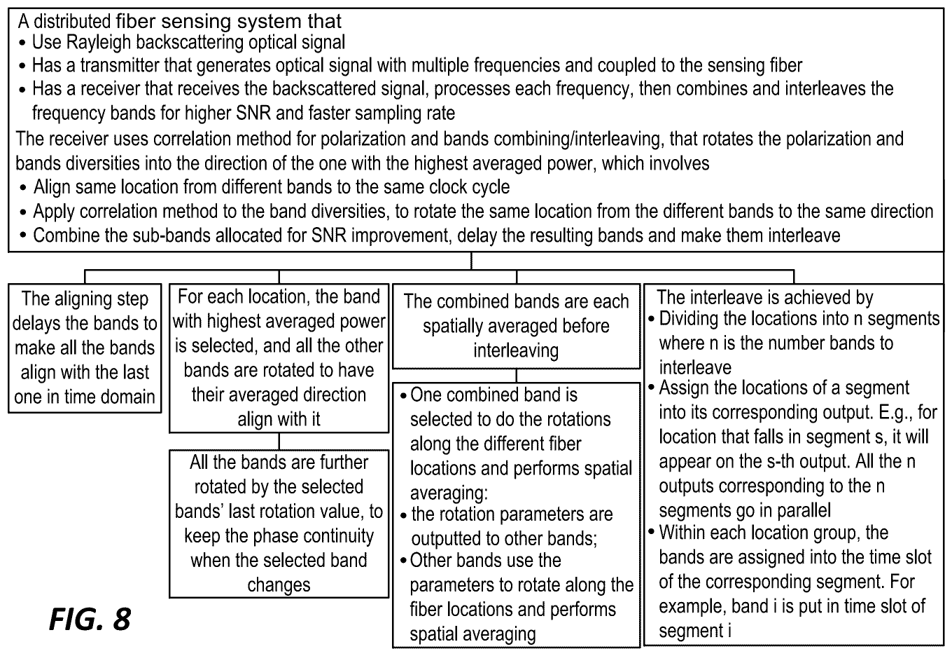

FIG. 8 shows a feature diagram in hierarchical format of features and operation steps of systems and methods according to aspects of the present disclosure.

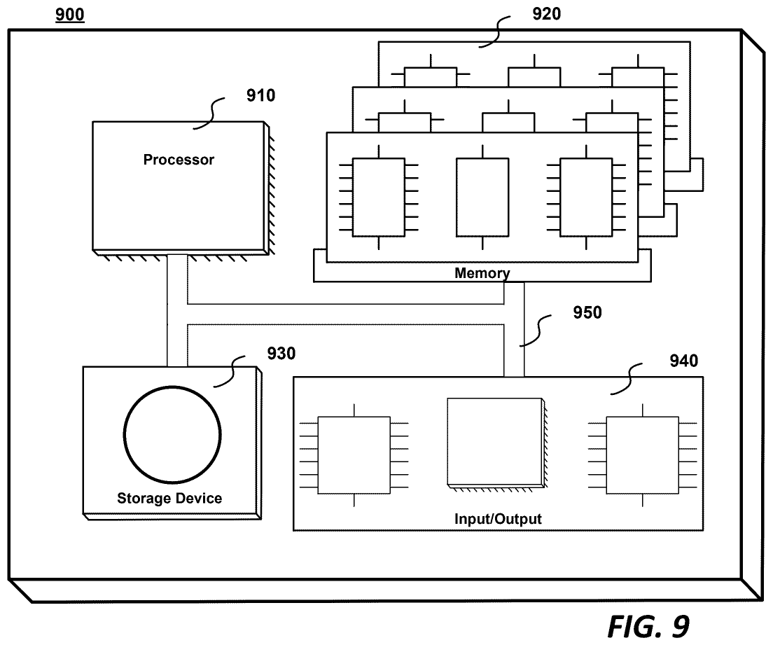

FIG. 9 is a schematic block diagram of an illustrative computer system in which aspects of the present disclosure may be executed.

As may be immediately appreciated, such a computer system may be integrated into another system and may be implemented via discrete elements or one or more integrated components. The computer system may comprise, for example, a computer running any of several operating systems. The above-described methods of the present disclosure may be implemented on the computer system 900 as stored program control instructions.

Computer system 900 includes processor 910, memory 920, storage device 930, and input/output structure 940. One or more input/output devices may include a display. One or more busses 950 typically interconnect the components, 910, 920, 930, and 940. Processor 910 may be a single or multicore. Additionally, the system may include accelerators etc., further comprising the system on a chip.

Processor 910 executes instructions in which embodiments of the present disclosure may comprise steps described in one or more of the Drawing figures. Such instructions may be stored in memory 920 or storage device 930. Data and/or information may be received and output using one or more input/output devices.

Memory 920 may store data and may be a computer-readable medium, such as volatile or non-volatile memory. Storage device 930 may provide storage for system 900 including for example, the previously described methods. In various aspects, storage device 930 may be a flash memory device, a disk drive, an optical disk device, or a tape device employing magnetic, optical, or other recording technologies.

Input/output structures 940 may provide input/output operations for system 900.

While we have presented our inventive concepts and description using specific examples, our invention is not so limited. Accordingly, the scope of our invention should be considered in view of the following claims.

1. A method of operating a distributed fiber optic sensing system, the method comprising:
generating, by an interrogator, multi-frequency interrogation signals and introducing the generated signals into an optical sensor fiber,
receiving, backscattered optical signals from the optical sensor fiber,
processing each frequency of the received backscattered signals and rotating a polarization and band diversity into a direction of one with the highest average power.

2. The method of claim 1 wherein the processing each frequency further comprises aligning frequencies received from a same location of the optical sensor fiber to a same clock cycle.

3. The method of claim 2 wherein the processing each frequency further comprises applying a correlation method to band diversities, and rotating signals from the same location of the optical sensor fiber from different bands to a same direction.

4. The method of claim 3 wherein the processing each frequency further comprises combining sub-bands allocated for signal-to-noise improvement and delaying and interleaving resulting bands.

5. The method of claim 4 wherein the aligning delays the bands such that all bands align with a last band in the time domain.

6. The method of claim 5 wherein for each location of the optical sensor fiber, the band exhibiting the highest average power is selected and all other bands are rotated such that their averaged direction align with the selected band rotation.

7. The method of claim 6 further comprising spatially averaging combined bands before interleaving.
